(19) United States
(12) Patent Application Publication
(10) Pub. No.: US 2017/0116523 A1
(43) Pub. Date: Apr. 27, 2017

(54) Quantum evolution method

(71) Applicant: HEFEI UNIVERSITY OF TECHNOLOGY, Hefei, Anhui (CN)

(72) Inventors: Yigang He, Hefei, Anhui (CN); Sheng Xiang, Hefei, Anhui (CN); Lei Zuo, Hefei, Anhui (CN); Baiqiang Yin, Hefei, Anhui (CN)

(21) Appl. No.: 15/316,840

(22) PCT Filed: Oct. 19, 2015
(86) PCT No.: PCT/CN2015/092174

§ 371 Date: Dec. 7, 2016

(30) Foreign Application Priority Data
Dec. 29, 2014 (CN) 201410831269.4

(51) Int. Cl. G06N 3/12; G06F 17/16; G06N 99/00; G06N 7/00

(52) U.S. Cl. CPC G06N 3/126; G06N 7/005; G06F 17/16; G06N 99/002

(57) ABSTRACT

A quantum evolution method includes steps of: according to the quantum evolution method, initializing a generation number t=0, and initializing a population Q(t)={q₁^{t}, q₂^{t}, . . . , qₙ^{t}}; observing Q(t) and generating P(t)={x ₁^{t}, x₂^{t}, . . . , xₙ^{t}}, wherein represents strings comprising 0 or 1 with a length of m; evaluating each xᵢ^{t} with an evaluation function, and inputting evaluating results into a fitness function F(t), F(t)={f₁^{t}, f₂^{t}. . . , fₙ^{t}}, wherein fᵢ^{t} represents a fitness of each individual; selecting an elite group E(t) from P(t) according to the fitness; evolving Q(t) through U(Δθᵢⱼ^{t}); inputting an optimal solution b of P(t) into B(t), wherein if the optimal solution is better than an original optimal solution in B(t), then replacing the original optimal solution; otherwise remaining the original optimal solution; and judging a shutdown condition, if satisfied, outputting the optimal solution; otherwise returning to the step (2) for further evolution. The method can effectively control a quantum evolution direction and improve method stability.

### CROSS REFERENCE OF RELATED APPLICATION

This is a U.S. National Stage under 35 U.S.0 371 of the International Application PCT/CN2015/092174, filed Oct. 19, 2015, which claims priority under 35 U.S.C. 119(a-d) to CN 201410831269.4, filed Dec. 29, 2014.

### BACKGROUND OF THE PRESENT INVENTION

Field of Invention

The present invention relates to a field of optimizing methods, and more particularly to a quantum evolution method introducing an elite group and a state preference.

Description of Related Arts

Quantum evolution methods are based on state vector expression of quantum, wherein probability amplitudes of quantum bits are used for representing chromosome encoding, in such a manner that a chromosome is able to express multiple superimposed states; and quantum revolving door and quantum NOT gate are used for chromosome updating, so as to achieve optimized solution of a target. However, conventional quantum convergence direction cannot be effectively controlled, which may cause degradation. Conventionally, there are many improvements for the quantum evolution methods, but none effectively overcomes the problem of convergence direction. Therefore, how to speed up the convergence of the quantum evolution methods, and how to control the convergence direction for preventing degradation, so as to improve method stability, are real key to quantum methods.

### SUMMARY OF THE PRESENT INVENTION

An object of the present invention is to overcome the above technical defects, and provide a quantum evolution method which effectively controls a convergence direction, wherein an elite group and a state preference are introduced for controlling the convergence direction, so as to improve method stability.

Accordingly, in order to accomplish the above object, the present invention provides:

a quantum evolution method, comprising steps of:

(1) according to the quantum evolution method, initializing a generation number t=0, and initializing a population Q(t)={q₁^{t}, q₂^{t}, . . . , qₙ^{t}}, wherein n is a population size, t is the generation number, qᵢ^{t} is a No. i individual in a No. t generation, and i ∈[1,n]; defining

$${q}_{i}^{t} = [ \begin{matrix}\begin{matrix}{α}_{i 1}^{t} \\ {β}_{i 1}^{t}\end{matrix} \vert \begin{matrix}{α}_{i 2}^{t} \\ {β}_{i 2}^{t}\end{matrix} \vert & \begin{matrix}⋯ \\ ⋯\end{matrix} & \begin{matrix}{α}_{im}^{t} \\ {β}_{im}^{t}\end{matrix} \vert ] ,\end{matrix}$$

wherein qᵢ^{t}, comprises m quantum bits, α represents a probability of each of the quantum bits that a state thereof is 0, β represents a probability of each of the quantum bits that the state thereof is 1, and |α|²+|β|²=1; wherein the quantum bits are randomly generated, and satisfy an equation:

(αᵢⱼ^{t}, βᵢⱼ^{t})=(sign(rand[0,1]−0.5)*/\sqrt{2}, sign(ramd[0,1]−0.5)*/\sqrt{2}),

wherein αᵢⱼ^{t} represents a probability of a No. j quantum bit of the No. i individual in the No. t generation that a state thereof is 0, and βᵢⱼ^{t} represents a probability of the No. j quantum bit of the No. i individual in the No. t generation that a state thereof is 1; initializing an optimal solution collection B(t), and inputting a string b, which comprises m 0-characters, into B(t) as an initial optimal solution;

(2) observing Q(t), and observing all individuals in the No. t generation, wherein for qᵢ^{t}, the m quantum bits are all observed for generating a string xᵢ^{t} with a length of m, wherein i is a corresponding individual, t is the generation number, and all individuals in the string xᵢ^{t} correspond to the quantum bits of qᵢ^{t}; if a quantum bit is 0, then 0 is written to a corresponding location in the string xᵢ^{t}, and if the quantum bit is 1, the 1 is written to the corresponding location in the string xᵢ^{t}; finally generating P(t)={x₁^{t}, x₂^{t}, . . . , xₙ^{t };}

(3) evaluating each xᵢ^{t} with an evaluation function, and inputting evaluating results into a fitness function F(t), F(t)={f₁^{t}, f₂^{t}, . . . , fₙ^{t}}, wherein fᵢ^{t} represents a fitness of qᵢ^{t} which is the No. i individual in the No. t generation, and n is the population size of the No. t generation;

(4) selecting an elite group E(t) from P(t), specifically comprising steps of:

(4.1) comparing all the individuals in the No. t generation with a worst individual of the No. t generation which is evaluated by the fitness function in the step (3), constructing \tilde{f}ᵢ^{t}=abs(fᵢ^{t}−min(F(t)));

(4.2) representing a probability that xᵢ^{t} enters the elite group by a probability function Sᵢ^{t},

$${s}_{i}^{t} = {\tilde{f}}_{i}^{t} / {\sum }_{i = 1}^{n} {\tilde{f}}_{i}^{t} ,$$

and constructing S(t)={s₁^{t}, s₂^{t}, . . . , sₙ^{t}}; and

(4.3) based on S(t), deciding whether the individuals in P(t) are selected to enter the elite group E(t) by a roulette method, E(t)={e₁^{t}, e₂^{t}, . . . , eₚ^{t}}, wherein p is a total individual quantity in the elite group;

(5) evolving the No. t generation population Q(t) through

$$U ( Δ {θ}_{ij}^{t} ) = [ \begin{matrix}cos ( Δ {θ}_{ij}^{t} ) & - sin ( {Δθ}_{ij}^{t} ) \\ sin ( {Δθ}_{ij}^{t} ) & cos ( {Δθ}_{ij}^{t} )\end{matrix} ] ,$$

so as to obtain a No. t+1 generation population Q(t+1),

$${Δθ}_{ij}^{t} = sign ( {α}_{ij}^{t} {β}_{ij}^{t} ) \frac{1}{p} {\sum }_{k = 1}^{p} {Δφ}_{ij}^{k} ,$$

wherein sign(αᵢⱼ^{t}βᵢⱼ^{t}) represents a quadrant location of a current quantum bit,

$$sign ( {α}_{j}^{1} {β}_{j}^{1} ) = \{ \begin{matrix}1 & 1 st or 3 rd quadrant \\ - 1 & 2 nd o r 4 th quadrant\end{matrix} , and \frac{1}{p} {\sum }_{k = 1}^{p} {Δφ}_{ij}^{k}$$

is a phase angle rotation weight of the elite group E(t), so the elite group actively guides evolution of the whole population; a value of Δφᵢⱼ^{k} is selected according to: 1) if the individual qᵢ^{t} in the No. t generation enters the elite group, then Δφᵢⱼ^{k}=0; 2) if the individual qᵢ^{t} in the No. t generation fails to enter the elite group and xᵢⱼ^{t}=eₖⱼ^{t}, then Δφᵢⱼ^{k}=0; 3) if the individual qᵢ^{t} in the No. t generation fails to enter the elite group while xᵢⱼ^{t} is in a ‘0’ state and eₖⱼ^{t} is in a ‘1’ state, then Δφᵢⱼ^{k}=φ₁, wherein φ₁ is a rotation value evolving towards the ‘1’ state, so as to increase a probability that xᵢⱼ^{t} evolves from the ‘0’ state to the ‘1’ state; and 4) if the individual qᵢ^{t} in the No. t generation fails to enter the elite group while xᵢⱼ^{t} is in the ‘1’ state and eₖⱼ^{t} is in the ‘0’ state, then Δφᵢⱼ^{k}=φ₀, wherein φ₀ is a rotation value evolving towards the ‘0’ state, so as to increase a probability that xᵢⱼ^{t} evolves from the ‘1’ state to the ‘0’ state; wherein xᵢ^{t} is the quantum bits of the individual qᵢ^{t} in the No. t generation, which is determined in the step (2); and eₖ^{t} is all individuals of the elite group E(t), which is determined in the step (4), k ∈[1, p], xᵢⱼ^{t} and eₖⱼ^{t} respectively represent the No. j quantum bit of xᵢ^{t} and eₖ^{t} in the No. t generation;

Δφᵢⱼ^{k} values

| xᵢⱼ^{t} | eₖⱼ^{t} | f (xᵢ^{t}) ≦ f (eₖ^{t}) | Δφᵢⱼ^{k} |
|---|---|---|---|
| * | * | × | 0 |
| 0 | 0 | ✓ | 0 |
| 0 | 1 | ✓ | φ₁ |
| 1 | 0 | ✓ | φ₀ |
| 1 | 1 | ✓ | 0 |

for controlling an evolution direction so as to uniformly evolve towards the ‘1’ state, introducing a state preference for further weighting, specifically comprising steps of: when the individual qᵢ^{t} in the No. t generation fails to enter the elite group while xᵢⱼ^{t} is in the ‘0’ state and eₖⱼ^{t} is in the ‘1’ state, increasing a value of φ₁ so as to increase a probability that xᵢⱼ^{t} evolves from the ‘0’ state to the ‘1’ state; when the individual qᵢ^{t} in the No. t generation fails to enter the elite group while xᵢⱼ^{t} is in the ‘1’ state and eₖⱼ^{t} is in the ‘0’ state, decreasing a value of φ₀ so as to decrease a probability that xᵢⱼ^{t} evolves from the ‘1’ state to the ‘0’ state; in such a manner that total evolution is towards the ‘1’ state;

(6) using xᵢ^{t} with a highest fitness, which is selected from P(t) by the fitness function F(t) in the step (3), as an optimal solution of the No. t generation; comparing the optimal solution of the No. t generation with an optimal solution b obtained before the No. t generation, wherein if the optimal solution of the No. t generation is better than the optimal solution before the No. t generation, then the optimal solution of the No. t generation is inputted into B(t−1) for replacing b, so as to obtain B(t); otherwise, the original optimal solution b in B(t−1) remains, so as to obtain B(t); and (7) judging a shutdown condition, specifically: when the optimal solution b in the B(t) is not a globally optimal solution, b is a string comprising m 1-characters and the generation number t is lower than a certain limit, executing t=t+1, and returning to the step (2) for further evolution; otherwise, outputting the optimal solution b in the B(t).

Preferably, in the step (5), introducing the state preference for controlling a convergence direction of the quantum evolution method specifically comprises steps of: using φ₁ and φ₀ for increasing or decreasing a state value of the current quantum bit, wherein if the current quantum bit is in the ‘1’ state, a tendency that a quantum moves to 0 is decreased by decreasing φ₀ ; if the current quantum bit is in the ‘0’ state, a tendency that a quantum moves to 1 is increased by increasing φ₁.

Preferably, in the step (3), for evaluating each xᵢ^{t} the evaluation function, all quantum bits of xᵢ^{t} are added together, and a result thereof is inputted into F(t) as a fitness fᵢ^{t} of xᵢ^{t}.

Preferably, in the step (4.3), for deciding whether the individuals in P(t) are selected to enter the elite group E(t) by the roulette method based on S(t), the fitness fᵢ^{t} of all the individuals in the No. t generation is calculated, then a fitness sum

$${\sum }_{i = 1}^{n} {f}_{i}^{t}$$

of all the individuals in the No. t generation is calculated, probabilities that the individuals in P(t) enter the elite group E(t) is

$${f}_{i}^{t} = {\sum }_{i = 1}^{n} {f}_{i}^{t} ,$$

p individuals with highest probabilities are selected to enter the elite group E(t).

Preferably, in the step (6), b in the optimal solution collection B(t) is the optimal solution of the No. t generation, and an updating process thereof is: during initializing, the optimal solution b is the string comprising m 0-characters; when the generation number t=0, the optimal solution obtained through the step (2) and the step (3) is surely better than the initial optimal solution; as a result, replacing the initial optimal solution by the optimal solution, and inputting in the optimal solution collection B(t) as the optimal solution b, so as to obtain a current generation optimal solution collection B(0); when the generation number t=1, repeating the step (2) and the step (3), comparing an obtained optimal solution with the optimal solution in B(0), wherein if the optimal solution when t=1 is better than the optimal solution in B(0), then the optimal solution when t=1 is inputted into B(t) as b, so as to obtain a current generation optimal solution collection B(1); if the optimal solution when t=1 is worse than the optimal solution in B(0), then the original optimal solution b in B(1) remains, so as to obtain B(1); when the generation number is t, comparing the optimal solution of the No. t generation with the optimal solution b in B(t−1), so as to obtain B(t).

The present invention has a simple structure, and introduces the elite group and the state preference for weighting quantum evolution, which finally achieves optimized solution. By weighting control of the convergence direction, quantum degradation is inhibited and method stability is improved.

### BRIEF DESCRIPTION OF THE DRAWINGS

FIG. 1 is a flow chart of a quantum evolution method according to a preferred embodiment of the present invention.

FIG. 2 illustrates controlling an evolution direction by adjusting φ₀ and φ₁.

### DETAILED DESCRIPTION OF THE PREFERRED EMBODIMENT

Referring to drawings and a preferred embodiment, the present invention is further illustrated.

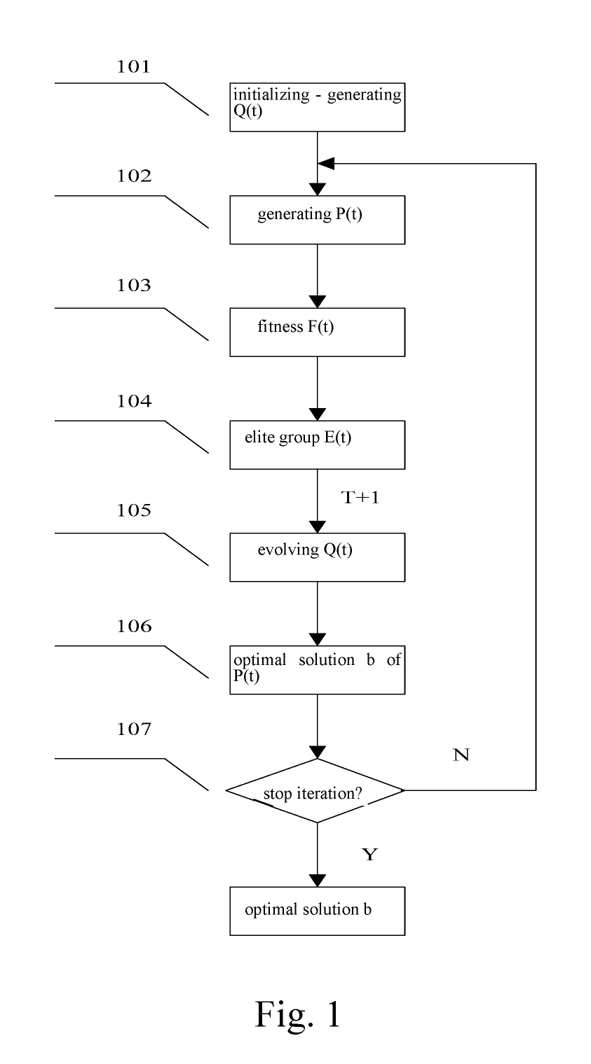

Referring to FIG. 1, a quantum evolution method of the present invention comprises steps of:

(1) executing a step 101, specifically: initializing a generation number t=0, wherein a population size n=20, a parallel population number N=30, and a max generation number is 10000 (i.e. t ∈[0,10000]);

$${q}_{i}^{t} = [ \begin{matrix}{α}_{i 1}^{t} \\ {β}_{i 1}^{t}\end{matrix} \vert \begin{matrix}{α}_{i 2}^{t} \\ {β}_{i 2}^{t}\end{matrix} \vert \begin{matrix}… & {α}_{im}^{t} \\ … & {β}_{im}^{t}\end{matrix} \vert ]$$

is a No. i individual in a No. t generation (i ∈[1, n]) , and qᵢ^{t} comprises m quantum bits; α and β respectively represent probabilities of a state of 0 or 1, and |α|²+|β|²=; wherein wherein the quantum bits are randomly generated, and satisfy an equation:

(αᵢⱼ^{t}, βᵢⱼ^{t})=(sign(rand[0,1]−0.5)*1/\sqrt{2}, sign(rand[0,1]−0.5)*1/\sqrt{2}),

wherein αᵢⱼ^{t} represents a probability of a No. j quantum bit of the No. i individual in the No. t generation that a state thereof is 0, and βᵢⱼ^{t} represents a probability of the No. j quantum bit of the No. i individual in the No. t generation that a state thereof is 1; inputting a string b, which comprises m 0-characters, into B(t) as an optimal solution;

(2) executing a step 102, specifically: observing all individuals in the No. t generation, and generating P(t)={x₁^{t}, x₂^{t}, . . . , xₙ^{t}}, wherein xᵢ^{t} represents strings comprising 0 or 1 with a length of m, 0 means the individual is valueless and 1 means valuable;

(3) executing a step 103, specifically: evaluating each xᵢ^{t} of P(t) in the No. t generation, constructing a fitness function F(t)={f₁^{t}, f₂^{t}, . . . , fₙ^{t}}, wherein fᵢ^{t} represents a fitness of the No. i individual in the No. t generation;

(4) executing a step 104, specifically: constructing an elite group E(t), and comparing all values in the fitness function F(t) with a min value in the F(t) for obtaining \tilde{f}ᵢ^{t} with an equation:

\tilde{f}ᵢ^{t}=abs(fᵢ^{t}−min(F(t)));

constructing a probability function Sᵢ^{t}, which represents a probability that xᵢ^{t} of P(t) enters the elite group, with an equation:

$${s}_{i}^{t} = {\tilde{f}}_{i}^{t} / {\sum }_{i = 1}^{n} {\tilde{f}}_{i}^{t} ;$$

constructing S(t)={s₁^{t}, s₂^{t}, . . . , sₙ^{t}};

deciding whether the individuals in P(t) are selected to enter the elite group E(t) by a roulette method, E(t)={e₁^{t}, e₂^{t}, . . . , eₚ^{t}}, wherein p is a total individual quantity in the elite group; here, p=20;

(5) executing a step 105, specifically: evolving Q(t), and evolving the quantum bits based on the elite group with

$$U ( {Δθ}_{ij}^{t} ) = [ \begin{matrix}cos ( {Δθ}_{ij}^{t} ) & - sin ( {Δθ}_{ij}^{t} ) \\ sin ( {Δθ}_{ij}^{t} ) & cos ( {Δθ}_{ij}^{t} )\end{matrix} ]$$

for rotating Q(t), wherein

$${Δθ}_{ij}^{t} = sign ( {α}_{ij}^{t} {β}_{ij}^{t} ) \frac{1}{p} {\sum }_{k = 1}^{p} {Δφ}_{ij}^{k} ,$$

sign(αᵢⱼ^{t}βᵢⱼ^{t}) represents a quadrant location of a current quantum bit,

$$sign ( {α}_{ij}^{t} {β}_{ij}^{t} ) = \{ \begin{matrix}1 & 1 st or 3 r d quadrant \\ - 1 & 2 nd or 4 th quadrant\end{matrix} , and \frac{1}{p} {\sum }_{k = 1}^{p} {Δφ}_{ij}^{k}$$

is a phase angle rotation weight of the elite group E(t), so the elite group actively guides evolution of the whole population; values of Δφᵢⱼ^{k} are listed in Table 1;

TABLE 1
Δφᵢⱼ^{k} values

| xᵢⱼ^{t} | eₖⱼ^{t} | f (xᵢ^{t}) ≦ f (eₖ^{t}) | Δφᵢⱼ^{k} |
|---|---|---|---|
| * | * | × | 0 |
| 0 | 0 | ✓ | 0 |
| 0 | 1 | ✓ | φ₁ |
| 1 | 0 | ✓ | φ₀ |
| 1 | 1 | ✓ | 0 |

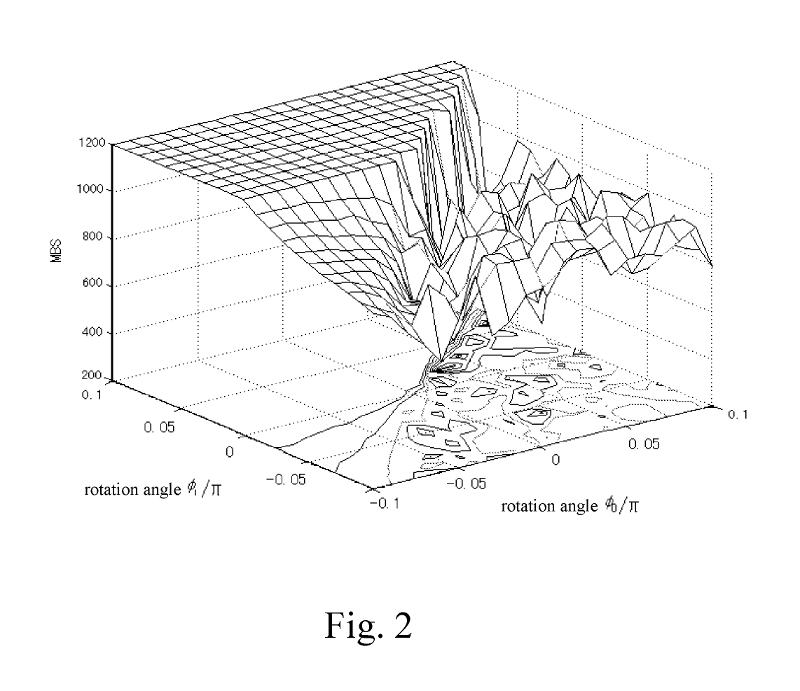

for preventing degeneration of conventional quantum evolution methods, introducing a state preference for further weighting, specifically comprising steps of: using φ₁ and φ₀ for increasing or decreasing a state value of the current quantum bit, wherein if the current quantum bit is in the ‘1’ state, a tendency that a quantum moves to 0 is decreased by decreasing φ₀ ; if the current quantum bit is in the ‘0’ state, a tendency that a quantum moves to 1 is increased by increasing φ₁; wherein values of φ₁ and φ₀ are determined by the population size and the individual quantity in the elite group, which is generally sufficient when 0≦φ₀≦φ₁, as shown in FIG. 2;

(6) executing a step 106, specifically: using xᵢ^{t} with a highest fitness of P(t) as an optimal solution of the No. t generation; comparing the optimal solution of the No. t generation with an optimal solution b obtained before the No. t generation, wherein if the optimal solution of the No. t generation is better than the optimal solution before the No. t generation, then the optimal solution of the No. t generation is inputted into B(t−1) for replacing b, so as to obtain B(t); otherwise, the original optimal solution b in B(t−1) remains, so as to obtain B(t); and

(7) executing a step 107, specifically: judging a shutdown condition, specifically: when the optimal solution b in the B(t) is not a globally optimal solution, b is a string comprising m 1-characters and the generation number t is lower than a certain limit, executing t=t+1, and returning to the step (2) for further evolution; otherwise, outputting the optimal solution b in the B(t).

### EXAMPLE

A famous NP problem—knapsack problem is adapted as an example. The problem is: under a certain knapsack volume, how to reach a max total price of items with different prices and sizes. There are five knapsacks with different volumes of 600, 1200, 1800, 2400 and 3000 in the example. Comparison is provided between the quantum evolution method of the present invention with the elite group and the state preference (PEQIEA), a quantum evolution method (QIEA), a quantum evolution method with H quantum (HQIEA), improved quantum evolution method (IQIEA), quantum evolution method with fitness (FQIEA), hybrid quantum evolution method (QEP), and a comprehensively learning quantum evolutionary approach (CLQIEA) for comparison.

TABLE 2
solution comparison of Knapsack problem

| | | mean square | | | | |
|---|---|---|---|---|---|---|
| volume | method | deviation | best | middle | worst | GS/UL |
| 600 | QIEA | 10000 | 3676.1290 | 3675.6275 | 3671.1261 | GS = 3679.8790 |
| | HQIEA | 10000 | 3676.1280 | 3670.6278 | 3666.1266 | UL = 3681.1291 |
| | IQIEA | 10000 | 3666.1287 | 3663.1251 | 3656.1290 | |
| | FQIEA | 7814 | 3681.1258 | 3679.2501 | 3670.9387 | |
| | QEP | 10000 | 3631.1214 | 3617.6242 | 3596.1278 | |
| | CLQIEA | 10000 | 3676.1289 | 3676.1277 | 3676.1256 | |
| | PEQIEA | 173 | 3681.1286 | 3681.1284 | 3681.1283 | |
| 1200 | QIEA | 10000 | 7365.4952 | 7357.9944 | 7355.4917 | GS = 7371.8498 |
| | HQIEA | 10000 | 7340.4905 | 7334.4700 | 7320.4842 | UL = 7375.4961 |
| | IQIEA | 10000 | 7320.4867 | 7310.9122 | 7295.1624 | |
| | FQIEA | 8894 | 7375.4902 | 7370.6721 | 7363.1028 | |
| | QEP | 10000 | 7230.4937 | 7208.9874 | 7185.4958 | |
| | CLQIEA | 10000 | 7365.4959 | 7363.4941 | 7360.4930 | |
| | PEQIEA | 216 | 7375.4961 | 7375.4960 | 7375.4957 | |
| 1800 | QIEA | 10000 | 11023.6642 | 11007.6652 | 10978.6658 | GS = 11036.5618 |
| | HQIEA | 10000 | 10963.6448 | 10942.1029 | 10913.6130 | UL = 11043.6659 |
| | IQIEA | 10000 | 10893.3635 | 10864.4902 | 10848.6453 | |
| | FQIEA | 8271 | 11043.6588 | 11039.4819 | 11025.4341 | |
| | QEP | 10000 | 10743.6641 | 10711.1526 | 10653.6633 | |
| | CLQIEA | 10000 | 11028.6620 | 11021.6642 | 11008.6656 | |
| | PEQIEA | 271 | 11043.6658 | 11043.6656 | 11043.6650 | |
| 2400 | QIEA | 10000 | 14699.7198 | 14679.7188 | 14649.7187 | GS = 14746.7553 |
| | HQIEA | 10000 | 14579.6499 | 14546.8915 | 14494.5388 | UL = 14749.7202 |
| | IQIEA | 10000 | 14403.3049 | 14376.8923 | 14344.2411 | |
| | FQIEA | 9699 | 14749.6244 | 14739.5228 | 14723.7171 | |
| | QEP | 10000 | 14274.7198 | 14206.6810 | 14164.7197 | |
| | CLQIEA | 10000 | 14709.7199 | 14703.7185 | 14684.7152 | |
| | PEQIEA | 353 | 14749.7201 | 14749.7197 | 14749.7184 | |
| 3000 | QIEA | 10000 | 18301.2696 | 18280.2692 | 18246.2699 | GS = 18374.7172 |
| | HQIEA | 10000 | 18061.2126 | 18031.8713 | 17984.6050 | UL = 18381.2708 |
| | IQIEA | 10000 | 17816.0103 | 17777.0292 | 17736.2377 | |
| | FQIEA | 10000 | 18379.8046 | 18370.6711 | 18357.2014 | |
| | QEP | 10000 | 17721.2648 | 17628.2355 | 17570.9420 | |
| | CLQIEA | 10000 | 18321.2701 | 18310.7693 | 18301.2676 | |
| | PEQIEA | 324 | 18381.2708 | 18381.2707 | 18381.2705 | |

wherein GS is a max value obtained by a greedy method, and UL is an ideal limit.

Referring to Table 2, values obtained by PEQIEA of the present invention are better than solutions in any other cases, while stability is also greater.

1-4. (canceled)

5. A quantum evolution method, comprising steps of:
(1) according to the quantum evolution method, initializing a generation number t=0, and initializing a population Q(t)={q₁^{t}, q₂^{t}, . . . , qₙ^{t}}, wherein n is a population size, t is the generation number, qᵢ^{t} is a No. i individual in a No. t generation, and i ∈[1, n]; defining
$${q}_{i}^{t} = [ \begin{matrix}{α}_{i 1}^{t} \\ {β}_{i 1}^{t}\end{matrix} \vert \begin{matrix}{α}_{i 2}^{t} \\ {β}_{i 2}^{t}\end{matrix} \vert \begin{matrix}… & {α}_{im}^{t} \\ … & {β}_{im}^{t}\end{matrix} \vert ] ,$$
wherein qᵢ^{t} comprises m quantum bits, a represents a probability of each of the quantum bits that a state thereof is 0, β represents a probability of each of the quantum bits that the state thereof is 1, and |α|²+|β|²=1; wherein the quantum bits are randomly generated, and satisfy an equation:
(αᵢⱼ^{t}, βᵢⱼ^{t})=(sign(rand[0,1]−0.5)*1/\sqrt{2}, sign(rand[0,1]−0.5)*1/\sqrt{2}),
wherein αᵢⱼ^{t} represents a probability of a No. j quantum bit of the No. i individual in the No. t generation that a state thereof is 0, and βᵢⱼ^{t} represents a probability of the No. j quantum bit of the No. i individual in the No. t generation that a state thereof is 1; initializing an optimal solution collection B(t), and inputting a string b, which comprises m 0-characters, into B(t) as an initial optimal solution;
(2) observing Q(t), and observing all individuals in the No. t generation, wherein for qᵢ^{t}, the m quantum bits are all observed for generating a string xᵢ^{t} with a length of m, wherein i is a corresponding individual, t is the generation number, and all individuals in the string xᵢ^{t} correspond to the quantum bits of qᵢ^{t}; if a quantum bit is 0, then 0 is written to a corresponding location in the string xᵢ^{t}, and if the quantum bit is 1, the 1 is written to the corresponding location in the string xᵢ^{t}; finally generating P(t)={x₁^{t}, x₂^{t}, . . . , xₙ^{t}};
(3) evaluating each xᵢ^{t} with an evaluation function, and inputting evaluating results into a fitness function F(t), F(t)={f₁^{t}, f₂^{t}, . . . , fₙ^{t}}, wherein fᵢ^{t} represents a fitness of qᵢ^{t} which is the No. i individual in the No. t generation, and n is the population size of the No. t generation;
(4) selecting an elite group E(t) from P(t), specifically comprising steps of:
(4.1) comparing all the individuals in the No. t generation with a worst individual of the No. t generation which is evaluated by the fitness function in the step (3), constructing \tilde{f}ᵢ^{t}=abs(fᵢ^{t}−min(F(t)));
(4.2) representing a probability that xᵢ^{t} the elite group by a probability function Sᵢ^{t},
$${s}_{i}^{t} = {\tilde{f}}_{i}^{t} / {\sum }_{i = 1}^{n} {\tilde{f}}_{i}^{t} ,$$
and constructing S(t)={s₁^{t}, s₂^{t}, . . . , sₙ^{t}}; and
(4.3) based on S(t), deciding whether the individuals in P(t) are selected to enter the elite group E(t) by a roulette method, E(t)={e₁^{t}, e₂^{t}, . . . , eₚ^{t}}, wherein p is a total individual quantity in the elite group;
(5) evolving the No. t generation population Q(t) through
$$U ( {Δθ}_{ij}^{t} ) = [ \begin{matrix}cos ( {Δθ}_{ij}^{t} ) & - sin ( {Δθ}_{ij}^{t} ) \\ sin ( {Δθ}_{ij}^{t} ) & cos ( {Δθ}_{ij}^{t} )\end{matrix} ] ,$$
so as to obtain a No. t+1 generation population Q(t+1),
$${Δθ}_{ij}^{t} = sign ( {α}_{ij}^{t} {β}_{ij}^{t} ) \frac{1}{p} {\sum }_{k = 1}^{p} {Δφ}_{ij}^{k} ,$$
wherein sign(αᵢⱼ^{t}βᵢⱼ^{t}) represents a quadrant location of a current quantum bit,
$$sign ( {α}_{ij}^{t} {β}_{ij}^{t} ) = \{ \begin{matrix}1 & 1 st or 3 r d quadrant \\ - 1 & 2 nd or 4 th quadrant\end{matrix} , and \frac{1}{p} {\sum }_{k = 1}^{p} {Δφ}_{ij}^{k}$$
is a phase angle rotation weight of the elite group E(t), so the elite group actively guides evolution of the whole population; a value of Δφᵢⱼ^{k} is selected according to: 1) if the individual qᵢ^{t} in the No. t generation enters the elite group, then Δφᵢⱼ^{k}=0; 2) if the individual q^{t} in the No. t generation fails to enter the elite group and xᵢⱼ^{t}=eₖⱼ^{t}, then Δφᵢⱼ^{k}=0; 3) if the individual qᵢ^{t} in the No. t generation fails to enter the elite group while xᵢⱼ^{t} is in a ‘0’ state and eₖⱼ^{t} is in a ‘1’ state, then Δφᵢⱼ^{k}=φ₁, wherein φ₁ is a rotation value evolving towards the ‘1’ state, so as to increase a probability that xᵢⱼ^{t} evolves from the ‘0’ state to the ‘1’ state; and 4) if the individual qᵢ^{t} the No. t generation fails to enter the elite group while xᵢⱼ^{t} is in the ‘1’ state and eₖⱼ^{t} is in the ‘0’ state, then Δφᵢⱼ^{k}=φ₀ , wherein φ₀ is a rotation value evolving towards the ‘0’ state, so as to increase a probability that xᵢⱼ^{t} evolves from the ‘1’ state to the ‘0’ state; wherein xᵢ^{t} is the quantum bits of the individual qᵢ^{t} in the No. t generation, which is determined in the step (2); and eₖ^{t} is all individuals of the elite group E(t), which is determined in the step (4), k ∈[1, p], xᵢⱼ^{t} and eₖⱼ^{t} respectively represent the No. j quantum bit of xᵢ^{t} and eₖ^{t} in the No. t generation;
for controlling an evolution direction so as to uniformly evolve towards the ‘1’ state, introducing a state preference for further weighting, specifically comprising steps of: when the individual qᵢ^{t} the No. t generation fails to enter the elite group while xᵢⱼ^{t} is in the ‘0’ state and eₖⱼ^{t} is in the ‘1’ state, increasing a value of φ₁ so as to increase a probability that xᵢⱼ^{t} evolves from the ‘0’ state to the ‘1’ state; when the individual qᵢ^{t} in the No. t generation fails to enter the elite group while xᵢⱼ^{t} is in the ‘1’ state and eₖⱼ^{t} is in the ‘0’ state, decreasing a value of φ₀ so as to decrease a probability that xᵢⱼ^{t} evolves from the ‘1’ state to the ‘0’ state; in such a manner that total evolution is towards the ‘1’ state;
(6) using xᵢ^{t} with a highest fitness, which is selected from P(t) by the fitness function F(t) in the step (3), as an optimal solution of the No. t generation; comparing the optimal solution of the No. t generation with an optimal solution b obtained before the No. t generation, wherein if the optimal solution of the No. t generation is better than the optimal solution before the No. t generation, then the optimal solution of the No. t generation is inputted into B(t−1) for replacing b, so as to obtain B(t); otherwise, the original optimal solution b in B(t−1) remains, so as to obtain B(t); and
(7) judging a shutdown condition, specifically: when the optimal solution b in the B(t) is not a globally optimal solution, b is a string comprising m 1-characters and the generation number t is lower than a certain limit, executing t=t+1, and returning to the step (2) for further evolution; otherwise, outputting the optimal solution b in the B(t).

6. The quantum evolution method, as recited in claim 5, wherein in the step (3), for evaluating each xᵢ^{t} with the evaluation function, all quantum bits of xᵢ^{t} are added together, and a result thereof is inputted into F(t) as a fitness fᵢ^{t} of xᵢ^{t}.

7. The quantum evolution method, as recited in claim 5, wherein in the step (4.3), for deciding whether the individuals in P(t) are selected to enter the elite group E(t) by the roulette method based on S(t), the fitness fᵢ^{t} of all the individuals in the No. t generation is calculated, then a fitness sum
$${\sum }_{i = 1}^{n} {f}_{i}^{t}$$
of all the individuals in the No. t generation is calculated, probabilities that the individuals in P(t) enter the elite group E(t) is
$${f}_{i}^{t} / {\sum }_{i = 1}^{n} {f}_{i}^{t} ,$$
p individuals with highest probabilities are selected to enter the elite group E(t).

8. The quantum evolution method, as recited in claim 6, wherein in the step (4.3), for deciding whether the individuals in P(t) are selected to enter the elite group E(t) by the roulette method based on S(t), the fitness fᵢ^{t} of all the individuals in the No. t generation is calculated, then a fitness sum
$${\sum }_{i = 1}^{n} {f}_{i}^{t}$$
of all the individuals in the No. t generation is calculated, probabilities that the individuals in P(t) enter the elite group E(t) is
$${f}_{i}^{t} / {\sum }_{i = 1}^{n} {f}_{i}^{t} ,$$
p individuals with highest probabilities are selected to enter the elite group E(t).

9. The quantum evolution method, as recited in claim 5, wherein in the step (6), b in the optimal solution collection B(t) is the optimal solution of the No. t generation, and an updating process thereof is: during initializing, the optimal solution b is the string comprising m 0-characters; when the generation number t=0, the optimal solution obtained through the step (2) and the step (3) is surely better than the initial optimal solution; as a result, replacing the initial optimal solution by the optimal solution, and inputting in the optimal solution collection B(t) as the optimal solution b, so as to obtain a current generation optimal solution collection B(0); when the generation number t=1, repeating the step (2) and the step (3), comparing an obtained optimal solution with the optimal solution in B(0), wherein if the optimal solution when t=1 is better than the optimal solution in B(0), then the optimal solution when t=1 is inputted into B(t) as b, so as to obtain a current generation optimal solution collection B(1); if the optimal solution when t=1 is worse than the optimal solution in B(0), then the original optimal solution b in B(1) remains, so as to obtain B(1); when the generation number is t, comparing the optimal solution of the No. t generation with the optimal solution b in B(t−1), so as to obtain B(t).
